(19) United States
(12) Patent Application Publication
(10) Pub. No.: US 2013/0187741 A1
(43) Pub. Date: Jul. 25, 2013

(54) AUTO-TRANSFORMER RECTIFIER UNIT CORE

(71) Applicants: Timothy Arn Goodrich, Rockford, IL (US); Gary L. Galloway, Rockford, IL (US)

(72) Inventors: Timothy Arn Goodrich, Rockford, IL (US); Gary L. Galloway, Rockford, IL (US)

(73) Assignee: HAMILTON SUNDSTRAND CORPORATION, Windsor Locks, CT (US)

(21) Appl. No.: 13/357,183

(22) Filed: Jan. 24, 2012

(51) Int. Cl. H01F 27/28; H01F 27/24

(52) U.S. Cl. 336/170

(57) ABSTRACT

A ferromagnetic core includes a ferromagnetic center portion including a plurality of legs each receptive of a conductive winding. The plurality of legs extend from a common center point and are equally angularly spaced. A ferromagnetic outer ring is positioned around the center portion at an outer radial extent of the plurality of legs. A transformer includes a transformer core having a center portion. The center portion includes a plurality of legs extending from a common center point. The plurality of legs are equally angularly spaced. An outer ring is positioned around the center portion at an outer radial extent of the plurality of legs. A conductive winding is located at each leg.

### BACKGROUND OF THE INVENTION

The subject matter disclosed herein relates to auto-transformer rectifier units. More specifically, the subject matter disclosed herein relates to configuration and construction of a transformer core for an auto-transformer rectifier unit.

In some power system structures, including aircraft applications, rectifier circuits are used to convert AC power to DC power. These power system structures may also include a transformer, in which case the combined unit is referred to as a transformer rectifier unit. If the transformer is a non-isolating type, then it is called an auto-transformer rectifier unit (ATRU).

The transformer portion of the ATRU comprises a ferromagnetic core with one or more windings wrapped around a portion of the core. The core is typically formed from a stack of core laminations and is configured to define a magnetic flux path in the core in response to a voltage applied to the one or more windings. The typical core utilized in an ATRU is an EI-type core. The EI-type core has an E portion, named for its shape with 3 legs extending outwardly from a spine. The windings, each a phase of a three-phase system, are installed on the legs, and an I portion is assembled to an open end of the E portion. Alternatively, tape-wound S-cores are often utilized. These typical configurations have an imbalance due to different magnetic path lengths between the phases. Further, the cores have many areas of flux crowding, and other areas of low or even no flux. The areas of low or no flux in particular equate excess material and a lost potential weight savings in the ATRU.

### BRIEF DESCRIPTION OF THE INVENTION

In one embodiment, a ferromagnetic core includes a ferromagnetic center portion including a plurality of legs each receptive of a conductive winding. The plurality of legs extend from a common center point and are equally angularly spaced. A ferromagnetic outer ring is positioned around the center portion at an outer radial extent of the plurality of legs.

In another embodiment, a transformer includes a transformer core having a center portion. The center portion includes a plurality of legs extending from a common center point. The plurality of legs are equally angularly spaced. An outer ring is positioned around the center portion at an outer radial extent of the plurality of legs. A conductive winding is located at one or more legs of the plurality of legs.

In yet another embodiment, a three-phase transformer includes a transformer core having a center portion. The center portion includes three legs extending from a common center point. The three legs are equally angularly spaced. An outer ring is located around the center portion at an outer radial extent of the legs. A conductive phase winding is located at each leg.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partially exploded view of an embodiment of a core of a transformer;

FIG. 2 is a perspective view of an embodiment of a transformer;

FIG. 3 is a partial cross-sectional view of an embodiment of a transformer core;

FIG. 4 is a partial cross-sectional view of another embodiment of a transformer core;

FIG. 5 is a partial cross-sectional view of yet another embodiment of a transformer core; and

FIG. 6 is a partial cross-sectional view of still another embodiment of a transformer core.

The detailed description explains embodiments of the invention, together with advantages and features, by way of example with reference to the drawings.

### DETAILED DESCRIPTION OF THE INVENTION

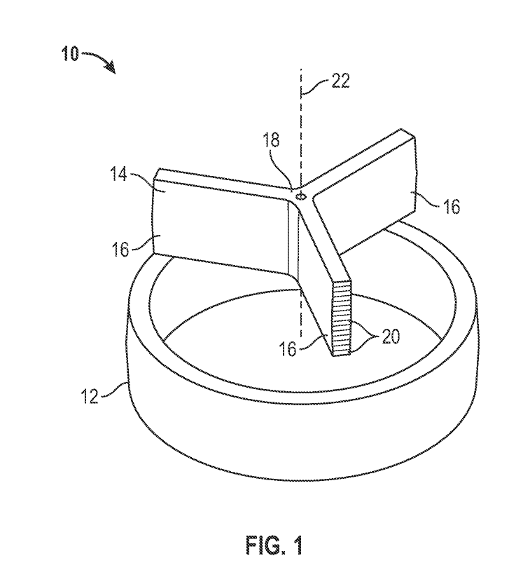

Shown in FIG. 1 is a partially exploded view of a magnetic core 10 of a transformer, in this embodiment a 3-phase auto-transformer rectifier unit (ATRU). It is to be appreciated that, while the description below relates to a magnetic core for an ATRU, other components, such as three-phase inductors, would benefit from the improvements described herein. The core 10 includes an outer ring 12 and a center portion 14 including three legs 16 extending radially outwardly from a center point 18 toward the outer ring 12. The outer ring 12 shares the common center point 18 with the center portion 14. The three legs 16 are substantially equally spaced around the center point. That is, in one embodiment, substantially equal angles exist between adjacent legs 16.

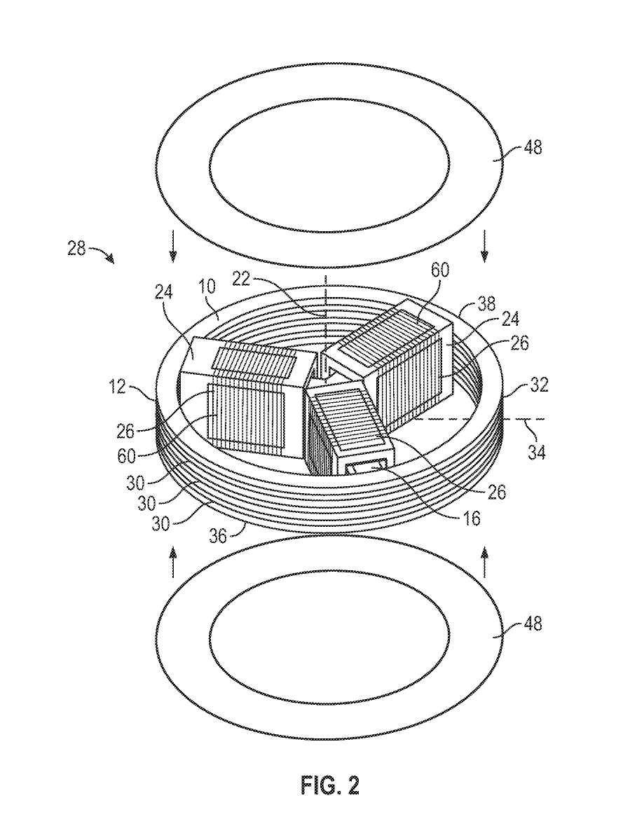

The center portion 14 is formed from a plurality of center portion laminations 20 of a ferromagnetic material stacked along a stacking axis 22. In other embodiments, however, the center portion 14 may be formed via a tape winding process. As shown in FIG. 2, a bobbin 24 is installed onto each leg 16 to receive a winding 26 of at least one conductor 60, which is wound onto the bobbin 24. Each winding 26 represents a phase of a transformer 28 of the three-phase ATRU. The bobbins 24 are typically formed from a plastic material. In some embodiments, the winding 26 is wound onto the bobbin 24 prior to installation onto the leg 16, while in other embodiments, the winding 26 may be wound onto the bobbin 24 after bobbin 24 installation onto the leg 16. Further, while bobbins 24 are included in the embodiment of FIG. 2, it is to be appreciated that in other embodiments, the windings 26 may be wound directly on the legs 16.

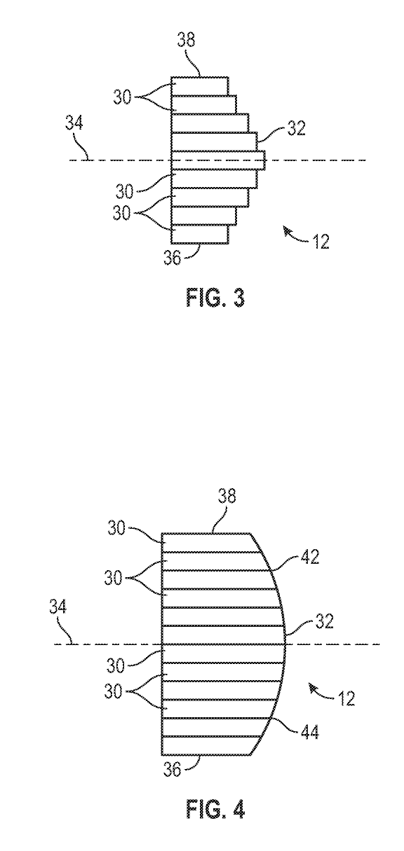

The outer ring 12 is formed separately from the center portion, and is formed from a plurality of ferromagnetic ring laminations 30 stacked along the stacking axis 22. In some embodiments, the individual laminations 30 have a thickness between about 1 and 2 millimeters, or between about 0.039 inches and about 0.079 inches. It is to be appreciated, however, that thinner laminations 30, for example, between 0.05 mm and 1 mm thickness, or between about 0.0019 inches and 0.039 inches, may be utilized. Further, in some embodiments, the outer ring 12 and/or the center portion 14 may be formed from constructions other than a stack of laminations. For example, the outer ring 12 and/or the center portion 14 may be formed from pressed & fired powder metal or ferrite, which are ferromagnetic materials. In one or more embodiments, to reduce weight of the core 10, and thus the ATRU, an outer radius 32 of the outer ring 12 is tapered along the stacking axis 22 from an axial center 34 of the outer ring 12. Examples of such embodiments are shown in FIGS. 3-5. The tapering eliminates material, which if included in the outer ring, would have no magnetic flux, or only low levels of magnetic flux therethrough as shown by magnetic analysis methods, such as finite element analysis.

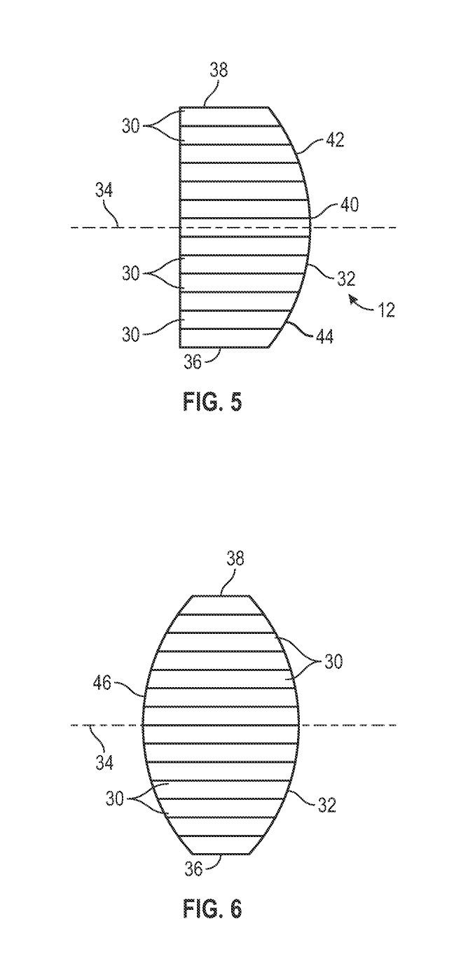

Referring to FIG. 3, in one embodiment, the outer ring 12 is tapered by stacking ring laminations 30 of progressively increasing outer radius 32 from a bottom 36 of the outer ring 12 to the axial center 34, then stacking ring laminations 30 of progressively decreasing outer radius 32 from the axial center 34 to a top 38 of the outer ring 12. This results in a stepped taper configuration. In another embodiment, as shown in FIG. 4, in addition to the progressively increasing and progressively decreasing outer radius 32 of FIG. 3, the outer radius 32 of each ring lamination 30 is tapered along the stacking axis 22, resulting in an outer ring 12 having a continuously tapered outer radius 32. In other embodiments, as shown in FIG. 5, an axially center portion 40 of the outer ring 12 has a constant outer radius 32, while only an upper portion 42 and a lower portion 44 of the outer ring 12 is tapered. Further, as shown in FIG. 6, an inner radius 46 of the outer ring 12 may be similarly tapered. The taper of the outer radius 32 and of the inner radius 46 may be, for example, substantially linear, arcuate, or a combination of the two. In some embodiments, a taper angle from the axial center 34 of the outer ring 12 to the bottom 36 and/or the top 38 of the outer ring may be between about 60 and 75 degrees.

Referring again to FIG. 2, the outer ring 12 is installed around the center portion 14 after the bobbins 24 and windings 26 are installed on the legs 16. The outer ring 12 and the center portion 14 may be held together via a friction fit between the legs 16 and the outer ring 12, while in other embodiments, a securing feature such as for example, a shoulder on the outer ring 12 or a tab and slot arrangement may be utilized. Further, in some embodiments, a keeper ring 48 may be installed at the bottom 36 and/or top 38 of the outer ring 12 to secure the center portion 14 therebetween.

The configuration of core 10 described herein advantageously provides a common center node, or zero flux point, for the three windings 26 at the center point 18. This configuration also provides a short distance for connections between the windings 26 at the center point 18. Further, the equal spacing of the legs 16, and the circular outer ring 12 results in an equal flux path length for each of the three windings 26 improving magnetic field balance of the transformer 28. Further, the taper of the outer ring 12 removes areas which would otherwise have low levels of magnetic flux, thereby reducing weight of the transformer 28, while not reducing performance by not increasing flux crowding on the core 10 or flux leakage from the core 12.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A ferromagnetic core comprising:
a ferromagnetic center portion including a plurality of legs each receptive of a conductive winding, the plurality of legs extending from a common center axis, the plurality of legs being equally angularly spaced; and
a ferromagnetic outer ring disposed around the center portion at an outer radial extent of the plurality of legs, an outer radial surface of the outer ring extending curvilinearly along an axial length of the outer ring.

2. The transformer core of claim 1, wherein the plurality of legs includes at least three legs.

3. (canceled)

4. The transformer core of Claim 1, wherein the outer radial surface is symmetrical about an axial center of the outer ring.

5. The transformer core of claim 1, wherein the outer ring comprises a plurality of outer ring laminations stacked along a stacking axis.

6. The transformer core of claim 5, wherein an outer radius of at least one outer ring lamination of the plurality of outer ring laminations is tapered along the stacking axis.

7. The transformer core of claim 5, wherein an inner radius of at least one outer ring lamination of the plurality of outer ring laminations is tapered along the stacking axis.

8. The ferromagnetic core of claim 1, wherein the ferromagnetic core is one of a transformer core or an inductor core.

9. A transformer comprising:
a transformer core including:
a ferromagnetic center portion including a plurality of legs extending from a common center axis, the plurality of legs being equally angularly spaced from one another; and
a ferromagnetic outer ring disposed around the center portion at an outer radial extent of the plurality of legs, an outer radial surface of the outer ring extending curvilinearly along an axial length of the outer ring; and
a conductive winding disposed at each of the plurality of legs.

10. The transformer of claim 9, wherein the plurality of legs includes at least three legs.

11. (canceled)

12. The transformer of claim 9, wherein the outer ring comprises a plurality of outer ring laminations stacked along a stacking axis.

13. The transformer of claim 12, wherein an outer radius of at least one outer ring lamination of the plurality of outer ring laminations is tapered along the stacking axis.

14. The transformer of claim 9, further comprising a bobbin disposed on one or more legs of the plurality of legs, the conductive winding disposed on the bobbin.

15. The transformer of claim 9, further comprising a keeper ring disposed at one or more axial end of the transformer core to secure the center portion in the outer ring.

16. A three-phase transformer comprising:
a transformer core including:
a ferromagnetic center portion including three legs extending from a common center axis, the legs being equally angularly spaced from one another; and
an ferromagnetic outer ring disposed around the center portion at an outer radial extent of the legs, an outer radial surface of the outer ring extending curvilinearly along an axial length of the outer ring; and
a conductive phase winding disposed at each leg.

17. (canceled)

18. The transformer of claim 16, wherein the outer ring comprises a plurality of outer ring laminations stacked along a stacking axis.

19. The transformer of claim 18, wherein an outer radius of at least one outer ring lamination of the plurality of outer ring laminations is tapered along the stacking axis.

20. The transformer of claim 16, further comprising a bobbin disposed on one or more legs of the plurality of legs, the conductive phase winding wrapped around the bobbin.

21. The transformer of claim 16, further comprising a keeper ring disposed at one or more axial end of the transformer core to secure the center portion in the outer ring.
